(19) United States
(12) Patent Application Publication
(10) Pub. No.: US 2005/0130839 A1
(43) Pub. Date: Jun. 16, 2005

(54) Photocatalyst carrier

(75) Inventors: Kong-Wei Cheng, Hsinchu (TW); Ju-Chia Kuo, PingChen City (TW); Shih-Pu Chen, Hsinchu (TW); Jau-Chyn Huang, Hsinchu (TW)

Correspondence Address: TROXELL LAW OFFICE PLLC, 5205 Leesburg Pike, Suite 1404, Falls Church, VA, 22041, US

(73) Assignee: Industrial Technology Research Institute

(21) Appl. No.: 10/790,841

(22) Filed: Mar. 3, 2004

(30) Foreign Application Priority Data
Dec. 16, 2003 (TW) 92135483

(51) Int. Cl. B01J 23/02

(52) U.S. Cl. 502/439

(57) ABSTRACT

A photocatalyst carrier comprises a carrier and a photocatalyst, wherein the carrier having a surface is made of an electric conductive material, and the photocatalyst is coated unevenly onto the surface to form a plurality of photocatalyst electrodes. By applying the concept of electronic transmission, the existence probability of the electron-hole pair is increased for enabling the reactant to perform an oxidation-reduction reaction on the photocatalyst and carrier respectively so as to enhance the photocatalyst activity.

### 1. FIELD OF THE INVENTION

The present invention relates to a photocatalyst carrier, more particularly, to a photocatalyst carrier consisting of a conductive carrier unevenly coated with a photocatalyst.

### 2. DESCRIPTION OF THE PRIOR ARTS

In the development of sustainable energy, methods of converting waste substances into reusable energy sources have become the most frequently discussed and studied subjects. Although converting waste into energy source is technologically feasible, external energy, such as heat, and light, etc., is required for this reaction. For instance, when carbon dioxide is used in the process of converting one into usable hydrocarbon materials, such as methane or methanol, by using a catalyst to lower the free activation enthalpy energy of the reaction, a huge amount of energy reaction is required for reaction since carbon dioxide is a material with high thermodynamic stability. If the energy is supplied by heat, high temperature (700˜1000° C.) is required for this reaction. Obviously, such technology of conversion using heat to improve the reaction efficiency will require lots of energy for providing the high-temperature environment. However, if a chemical fuel is used as the energy source more carbon dioxide will be generated. Hence, converting a waste substance into a energy source by using heat and catalyst is not cost-effective, and also is not environmentally friendly.

On the other hand, if light can be used to directly excite a catalyst for converting waste products into an a fuel of energy source, the aforementioned shortcomings, which are the need of a huge amount of energy and the generation of more CO₂, can be avoided. A photocatalyst is a substance which will demonstrate a catalyst function if light hits and, in most cases, it is a light-sensitive semiconductor, such as TiO₂, capable of being used for converting waste products into a fuel of energy source. If a photocatalyst is coated evenly on a conductive carrier, the Fermi level of the photocatalyst being a semiconductor is higher than that of the conductive carrier such that the Fermi level at the joint of the two will curve upward. When a photon with an energy of h υ matches or exceeds the energy band gap of the photocatalyst TiO₂, an electron, e_{ch}⁻, is exited from the valence band into the conduction band, leaving the hole, hᵥₕ⁺, in valence band. The hᵥₕ⁺ means the hole in the valence, e_{ch}⁻, means the excited electron in conduction band, and the two together is referred as the electron-hole pair. Before the electron-hole pair recombine, the electron will move in the direction towards the carrier and be accumulated at the intersection of the conductive carrier and the photocatalyst, and the hole will move in the direction towards the surface of the photcatalyst. As a reactant is in contact with the surface of the photocatalyst, the reactant will perform an oxidation with the hole. However, if the excited electrons cannot be consumed effectively, the electrons accumulated at the intersection of the conductive carrier and the photocatalyst. The accumulated electrons will flow back to the photocatalyst and recombine with the holes, so that will lower the activity of the photocatalyst and decrease the reaction rate. As a result, such photocatalyst is not ideal for industrial processes and requires an immediate improvement.

### SUMMARY OF THE INVENTION

The primary object of the present invention is to provide a photocatalyst carrier capable of enhancing the activity of the photocatalyst and the chemical reaction efficiency.

To achieve the foregoing objective, the photocatalyst carrier comprises a carrier and a photocatalyst. The carrier is made of a conductive material and has a surface, and the photocatalyst is coated unevenly onto the surface so that a plurality of photoelectrodes is formed on the surface.

In addition, the present invention provides a photoconversion system using the photocatalyst carrier, the system comprises: the photocatalyst; a light source, illuminating the photocatalyst carrier for enabling the plural photoelectrodes arranged on the surface to perform an electron/hole separation; at least one reactant being in contact with the surface for performing oxidation-reduction reactions with the electron/hole.

Other and further features, advantages and benefits of the invention will become apparent in the following description taken in conjunction with the following drawings. It is to be understood that the foregoing general description and following detailed description are exemplary and explanatory but are not to be restrictive of the invention. The accompanying drawings are incorporated in and constitute a part of this application and, together with the description, serve to explain the principles of the invention in general terms. Like numerals refer to like parts throughout the disclosure.

### BRIEF DESCRIPTION OF THE DRAWINGS

FIG. 1A and FIG. 1B are a top view and a side view showing a photocatalyst carrier of the present invention respectively.

FIG. 2 is a diagram of a photocatalyst carrier according to a preferred embodiment of the present invention.

FIG. 3 is a schematic diagram depicting a photoconversion system of the present invention.

FIG. 4 is a schematic diagram depicting a photoconversion system according to another preferred embodiment of the present invention.

### DESCRIPTION OF THE PREFERRED EMBODIMENT

The photocatalyst carrier of the present invention is an improved photo-reactor, capable of enhancing the life time of the electron-hole pair and the photocatalyst activity by using the concept of photoelectron transmission and separation.

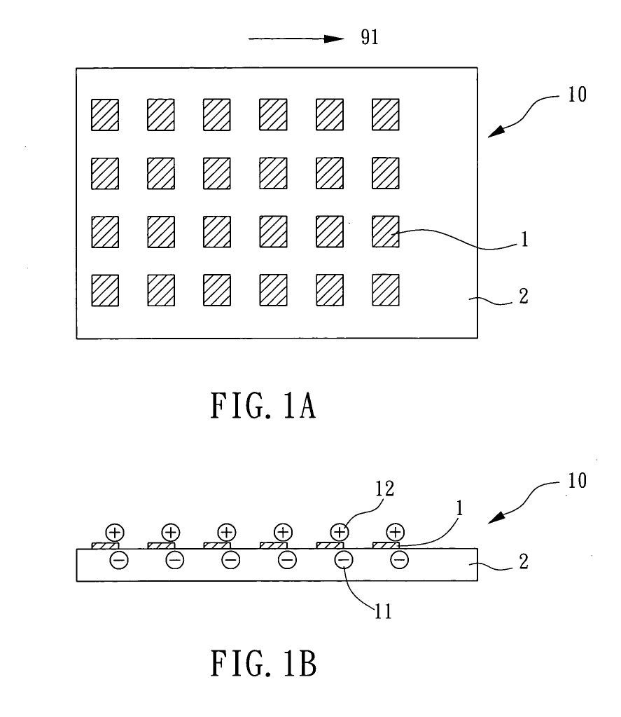

Please refer to FIG. 1A and FIG. 1B for the top view and side view of the photocatalyst carrier respectively. The photocatalyst carrier 10 comprises a carrier 2 and a photocatalyst 1. The carrier 2 is an electric-conductive-material-made rectangular board with a surface, and the electric conductive material could be copper, iron, aluminum, conductive glass or semiconductor known to those skilled in the art. The photocatalyst 1 is a thin-film photocatalyst, and the thickness of the film could be several nanometers to several millimeters, moreover, the photocatalyst 1 could be made of material containing such as titanium (Ti), zinc (Zn), tungsten (W), tin (Sn), Chromium (Cr), tantalum (Ta), and zirconium (Zr) or other derivative, and is coated onto the surface of the carrier 2 in the meshed form so as to define a plurality of photocatalyst electrodes 1 with at an appropriate distance apart. The shape of the photocatalyst electrode 1 could be one of the following: circular, rectangular, rhombus, and polygonal shapes, and so on. The photocatalyst 1 is coated using one of the following methods: plasma sputtering method, sol-gel processing method, and adhesive coating method, etc.

Knowing from the physical property of the semiconductor that the Fermi level of the photocatalyst 1 is higher than the Fermi level of the electrically conductive substance. Therefore, when the photocatalyst 1 is coated onto the electric-conductive carrier 2 in the meshed form, the Fermi level at the joint of the two materials will curve upward. The photocatalyst 1 excited by light will produce electron 11-hole 12 pair. Before the electron 11-hole 12 pair is recombined, the electron 11 will move in the direction towards the carrier 1 and be accumulated at the intersection of the carrier 2 and the photocatalyst 1, on the other hand, the hole 12 will move toward the surface of the photocatalyst electrode 1. When a reactant passes across the surface of the photocatalyst 1, the reactant will first be in contact with the hole 12 on the photocatalyst electrode to have an oxidation reaction. Following that, since the photocatalyst 1 is disposed in the meshed form so that electrons 11 are accumulated at the intersection of the carrier 2 and the photocatalyst electrode 1, the reactant can have a reduction reaction with the electrons 11 accumulated at the intersection of each photocatalyst carrier 2 and photocatalyst electrode 1 in order to exhaust the accumulated electrons and lower the reflux rate of the electrons flowing back to the photocatalyst electrode 1. In a preferred embodiment of the present invention, the photocatalyst 1 is titanium dioxide (TiO₂) and the reactant is water (H₂O). When the photocatalyst 1 is excited by light so as to generate the separation of electron 11-hole 12 pairs, and the water is flowing across the photocatalyst 1 in a first direction 91, the water (H₂O) is decomposed into oxygen (O₂) and hydrogen ion (H⁺) with hole 12, and following that the hydrogen ion (H⁺) continues to flow until it is in contact with the electron 11 accumulated on the carrier 2 to produce a reduction reaction converting the hydrogen ion into hydrogen molecule so as to decrease the number of the electrons 11 accumulated in the carrier 2 and lower the reflux rate of the electron 11 for enhancing the activity of the photocatalyst 1 and improving the reaction efficiency. The foregoing coating method of photocatalyst 1 is used to increase the probability of contact between the reactant and the accumulated electron 11 in order to reduce the number of accumulated electrons 11 and lower the reflux rate of the electron 11, wherein when the reactant (water) flows across the photocatalyst electrode 1 in a first direction 91, the reactant (water) will alternately flow across the photocatalyst electrode 1 and the carrier 2.

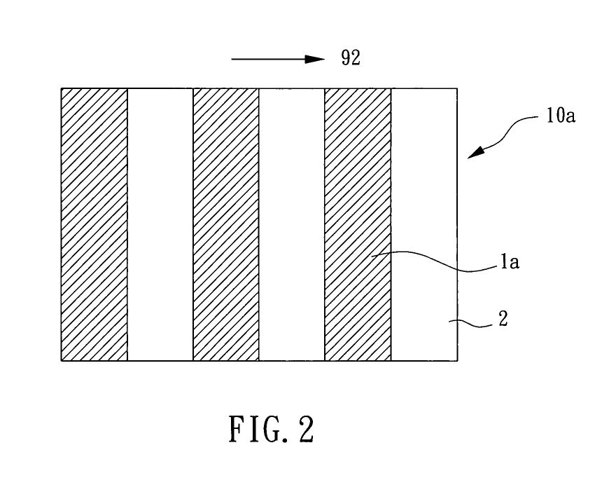

Please refer to FIG. 2, which is a diagram of a photocatalyst carrier according to another preferred embodiment of the present invention. The photocatalyst carrier 10a comprises a carrier 2 and a photocatalyst 1a. The photocatalyst 1a is a thin-film photocatalyst, and the thickness of the film could be several nanometers to several millimeters, moreover, the photocatalyst 1a could be made of material containing such as titanium (Ti), zinc (Zn), tungsten (W), tin (Sn), Chromium (Cr), tantalum (Ta), and zirconium (Zr) or other derivative, and is coated onto the surface of the carrier 2 in a bar shape so as to define a plurality of photocatalyst electrodes 1a at an appropriate distance apart. The photocatalyst 1a is coated using one of the following methods: plasma sputtering method, sol-gel processing method, and adhesive coating method, and so forth. For example, The photocatalyst electrode 1a is titanium dioxide (TiO₂) and the reactant is water (H₂O). When the photocatalyst 1a is excited by light so as to generate the separation of electron 11-hole 12 pairs, and the reactant (water) is flowing across the photocatalyst 1a in a second direction 92, the water (H₂O) is decomposed into oxygen (O₂) and hydrogen ion (H⁺), and following that the hydrogen ion (H⁺) continues to flow until it is in contact with the electron 11 accumulated on the carrier 2 to produce a reduction reaction converting the hydrogen ion into hydrogen molecule so as to decrease the number of the electrons 11 accumulated in the carrier 2 and lower the recombination rate of the electron 11-hole 12 pair for enhancing the activity of the photocatalyst 1a and improving the reaction efficiency.

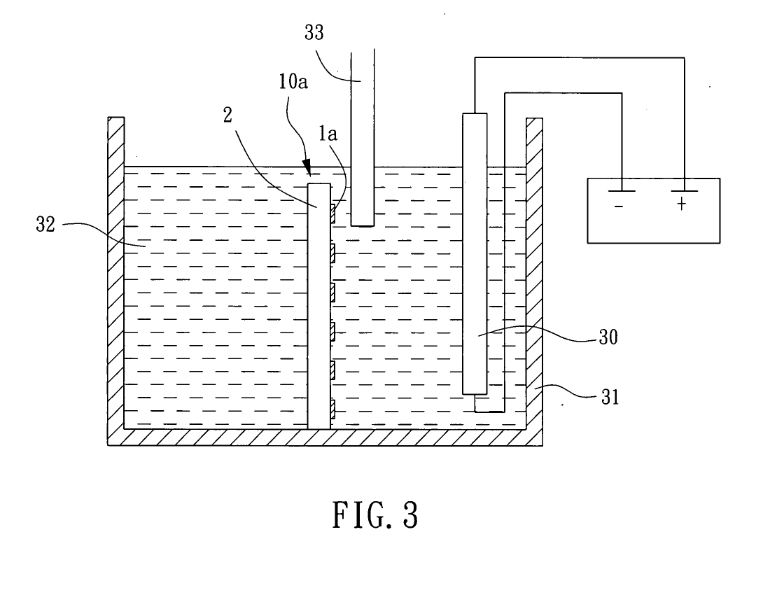

Please refer to FIG. 3, which is a schematic diagram depicting a photoconversion system using the photocatalyst of the present invention. The photoconversion system comprises a light source 30, a reaction tank 31, and a photocatalyst carrier 10a (as shown in FIG. 2). In the present preferred embodiment, carbon dioxide 33 and water 32 are provided as reactants for performing an oxidation-reduction on the same by using the light-excited photocatalyst to produce products, such as oxygen, methane, and methanol. Water is stored in the reaction tank 31, and the light source 30 provides light energy for exciting the photocatalyst electrode 1a on the photocatalyst carrier 10a to perform electron-hole separation. The water reacts with the holes of the excited titanium dioxide (which is a photocatalyst) to produce oxygen and hydrogen ion, and then the hydrogen ion performs a reduction reaction with the excited electron and carbon dioxide to produce methane and methanol, wherein the light source 30 is made of a partial reflective and partial transparent material so as to evenly disperse light energy onto the photocatalyst 1a. For instance, the light source 30 can be a light source similar to the optical fiber having wall consists of two layers: a core and a shell. In the conventional optical fiber that the refractive index of the core is larger than that of the shell so as to cause the total reflection of the light source, therefore, after the light from the light source enters the optical fiber, the light in the optical fiber is fully reflected and travels forward without dispersing through the wall of the optical fiber. The present invention adopts an optical fiber having a core with refraction rate smaller than that of the shell (which can no longer be referred as an optical fiber and is referred as light guider hereinafter). Of course, the structure similar to a back-lit board can be used as the material for making the wall of a light guider. Although the photocatalyst carrier 10a as shown in FIG. 3 has only one surface coated with photocatalyst electrodes 1a, the other side may also be coated with the photocatalyst electrodes 1a as needed.

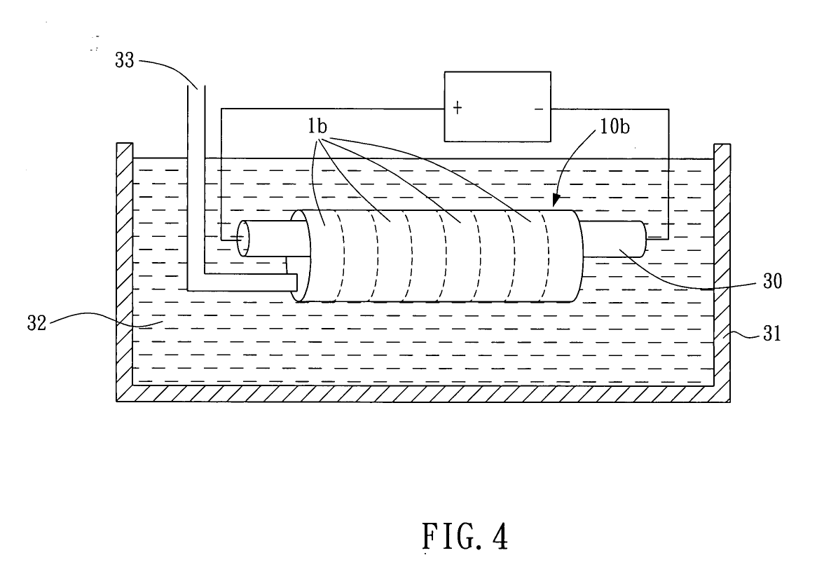

In addition, the shape of the photocatalyst carrier of the present invention is not limited to a rectangular board, but also can be a tube, including a circular tube, oval tube, or semicircular tube, and so on. Please refer to FIG. 4, which is a schematic diagram depicting a photoconversion system according to another preferred embodiment of the present invention. In the present preferred embodiment, carbon dioxide 33 and water 32 are provided as reactants for performing an oxidation-reduction on the same by using the light-excited photocatalyst 1b to produce products, such as oxygen, methane, and methanol. Water is stored in the reaction tank 31, and the light source 30 provides light energy for exciting the photocatalyst electrode 1b on the photocatalyst carrier 10b to perform electron-hole separation. The water reacts with the holes of the excited titanium dioxide (which is a photocatalyst) to produce oxygen and hydrogen ion, and then the hydrogen ion performs a reduction reaction with the excited electron and carbon dioxide to produce methane and methanol, wherein the photocatalyst carrier 10b is a circular tube and the photocatalyst 1b is coated circularly onto the internal wall thereof, so that the reactants (carbon dioxide 33 and water 32) passing through the tube will come across the photocatalyst electrode and carrier alternatively.

To sum up, the photocatalyst carrier of the present invention can effectively enhance the activity of the photocatalyst, and also improves the conversion rate of the chemical reaction by the photoelectric effect and electronic transmission, such that the high-temperature reaction or the low conversion rate according to the conventional technology is improved. The present invention can be used to establish a renewable energy technology of waste material and contribute to the processing procedure of disposals and poisonous matters.

1. A photocatalyst carrier, comprising:
a carrier, made of an electric conductive material and having a surface; and
a photocatalyst, unevenly coated on said surface to form a plurality of photocatalyst electrodes.

2. The photocatalyst carrier of claim 1, wherein a reactant comes into contact with said carrier and said photocatalyst electrode alternatively while flowing across said photocatalyst carrier.

3. The photocatalyst carrier of claim 1, wherein said photocatalyst is coated onto said surface in a meshed form for enabling a predetermined interval to be disposed between said plural photocatalyst electrodes.

4. The photocatalyst carrier of claim 1, wherein each photocatalyst electrode is a bar shape coated onto said surface and each photocatalyst electrode is separated by an predetermined distance.

5. The photocatalyst carrier of claim 1, wherein said photocatalyst electrode has a shape selected from the following: a circular, a rectangular, a rhombus, and a polygon.

6. The photocatalyst carrier of claim 1, wherein said carrier is made of a material selected from the following: copper, iron, aluminum, and electric conductive glass.

7. The photocatalyst carrier of claim 1, wherein said carrier is made of a semiconductor.

8. The photocatalyst carrier of claim 1, wherein said photocatalyst containing of one of the following materials: titanium (Ti), zinc (Zn), tungsten (W), tin (Sn), chromium (Cr), tantalum (Ta), and zirconium (Zr).

9. The photocatalyst carrier of claim 1, wherein said carrier is a rectangular board.

10. The photocatalyst carrier of claim 1, wherein said carrier has a second surface being coated unevenly with the photocatalyst for forming a plurality of photocatalyst electrodes disposed thereon.

11. The photocatalyst carrier of claim 1, wherein said carrier is a tubular object having a cross section in one of the following shapes: a circular shape, an oval shape, and a parabolic shape.

12. The photocatalyst carrier of claim 1, wherein said photocatalyst is coated using one of the following methods: a plasma sputtering method, a sol-gel processing method, and an adhesive coating method.

13. The photocatalyst carrier of claim 12, capable of being applied to a photoconversion system, the photoconversion system including:
said photocatalyst carrier;
a light source, illuminating said photocatalyst carrier for exciting said photocatalyst coated on said surface to perform an electron-hole separation; and
at least one reactant, being in contact with said surface to perform an oxidation-reduction reaction with said electron-hole.
